(19) United States
(12) Patent Application Publication
(10) Pub. No.: US 2008/0153054 A1
(43) Pub. Date: Jun. 26, 2008

(54) Shine Guide for Dental Surfaces and Method of Evaluating Shine of a Dental Surface

(76) Inventors: James G. Masters, Ringoes, NJ (US); Thomas S. Campbell, Plainsboro, NJ (US)

Correspondence Address: COLGATE-PALMOLIVE COMPANY, 909 RIVER ROAD, PISCATAWAY, NJ, 08855, US

(21) Appl. No.: 11/615,132

(22) Filed: Dec. 22, 2006

(51) Int. Cl. A61C 19/00

(52) U.S. Cl. 433/26

(57) ABSTRACT

A shine guide is disclosed for use in evaluating dental surfaces. The shine guide includes a substrate having an upper surface; and a plurality of gloss sections arranged on the upper surface of the substrate, wherein each of the plurality of gloss sections has a unique reflectivity measured in gloss units. Also described is a method for evaluating shine of a dental surface and packaging for dentifrices incorporating a shine guide.

### BACKGROUND OF THE INVENTION

It is known in the art to evaluate the shade of dental surfaces. This is typically done in the field of restorative dentistry in order to prepare implants or other restorative dental pieces. Such shade guides include comparative pieces of varying shades corresponding to the color and, in some cases, the opacity, of human enamel in order to try to prepare such additional restorative pieces that most closely approximate the color and opacity of the teeth in a patient's mouth. Conventional shade guides are known in the form of fan-type plates, singular and/or detachable plates and other insert pieces shaped in the form of teeth. Others are prepared from shade guides in the form of plastics filled with dental composite, which can be used and subsequently hardened.

It is also known that in coloring teeth through bleaching and other whitening techniques including whitening toothpastes and other dentifrice formulations, color guides are used for comparison to show the whitening effect of the dentifrice for the purpose of determining the particular whitening treatment and/or to determine whether the treatment was successful in decreasing the yellowing cast of the dental surface as the dentifrice progressively whitens the dental surface.

The degree of gloss and shine on a tooth surface is not generally evaluated. Shine or gloss is a measure of surface reflectivity and can be measured analytically using a gloss meter. However, such gloss meters are not readily available for use in everyday dental or home use to evaluate the performance of a gloss enhancing treatment. Accordingly, there is a need in the art for a way to evaluate performance of a gloss-enhancing dentifrice or other dental treatment.

### BRIEF SUMMARY OF THE INVENTION

The invention includes a shine guide that comprises a substrate having an upper surface; and a plurality of gloss sections arranged on the upper surface of the substrate, wherein each of the plurality of gloss sections has a unique reflectivity measured in gloss units.

Also included in the invention is packaging for a dentifrice having a shine guide, wherein the shine guide comprises a substrate having an upper surface; and a plurality of gloss sections arranged on the upper surface of the substrate, wherein each of the plurality of gloss sections has a unique reflectivity measured in gloss units.

A method for evaluating shine of a dental surface is also described herein. The method comprises comparing a dental surface to a dental shine guide.

### BRIEF DESCRIPTION OF THE SEVERAL VIEWS OF THE DRAWINGS

FIG. 1 is a perspective view of a shine chart according to one embodiment;

FIG. 2 is a enlarged, partial cross-sectional view of the shine chart of FIG. 1 taken along line A-A;

FIG. 3 is a top plan view of a further embodiment of a shine chart;

FIG. 4 is a perspective view of yet another embodiment of a shine chart arranged on an outer surface of a box for packaging of a dentifrice; and

FIG. 5 is a perspective view of still another embodiment of a shine chart arranged on an insert for a box for packaging of a dentifrice.

### DETAILED DESCRIPTION OF THE INVENTION

The invention is directed to a shine guide, packaging for a dentifrice having a shine guide, and a method for evaluating shine or gloss of a dental surface. A dentifrice, as used herein, refers to any oral care composition in useful form that typically remains in the mouth for a reasonably short time, which will closely contact surfaces of the teeth to which the composition is applied. Such materials include but are not limited to various types of toothpaste, tooth polish, tooth gel, mouthwash, mouth rinse, and paint on formulation.

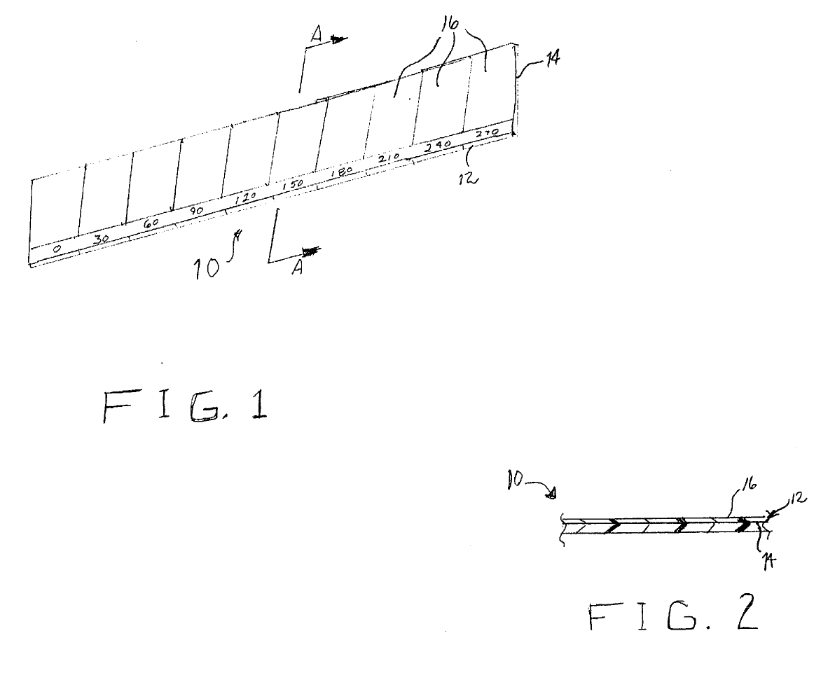

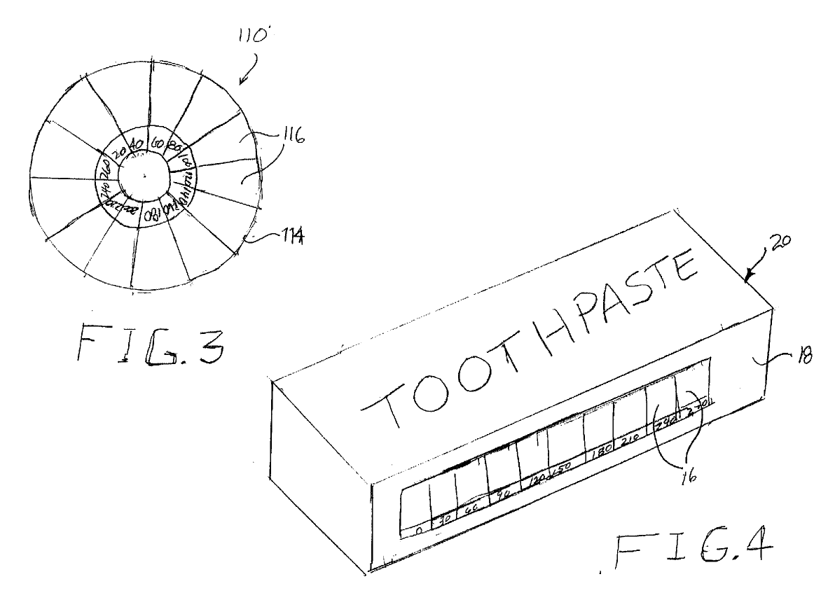

The shine guide preferably includes a substrate preferably having sufficient structural integrity to withstand handling and comparison with a dental surface. The shine guide, generally referred to herein as 10 as shown in FIG. 1, has substrate 12 having an upper surface 14 and a plurality of gloss sections 16. Each of the gloss sections is arranged on the upper surface 14 of the substrate 12. The substrate may be formed of any material. Preferably, the substrate is flexible. Suitable substrate materials include wood composites, foils, films, paper, cardboard, or polymeric materials, textiles and plastics. The substrate may be single layered, or may be a compound material such as a laminate, composites, pressboard. For example, suitable polymers may include various homopolymers and copolymers of standard thermoplastics suitable for consumer use and handling, including polyamides, polyolefins, polyvinyls, polyurethanes, silicones, and the like. It is possible also to provide a metallic foil, wax coating, or other backing to the substrate to reinforce the substrate and provide different flexibility characteristics if desired.

The substrate may be a single layer or multilayer material. The upper surface 14 of the substrate 12, shown in FIG. 1 has arranged thereon a plurality of gloss sections 16, each of which has a unique reflectivity measured in gloss units. The gloss sections may be formed as an integral unit with a multilayer substrate in which one of the upper layer incorporates the gloss sections. Alternatively, the substrate may include a coating on the upper surface of the substrate having the gloss sections arranged on the coating.

Such a coating or upper layer may be a polymeric coating having the gloss sections arranged thereon or decorative film incorporating the gloss sections. The latter is preferred in that the gloss sections can be incorporated on a thin substrate as part of an overall decorative film that may be applied to the substrate 12 or the substrate 12 can also be used as the bottom layer of a decorative film (such as a polymeric base film, e.g. a Mylar® or Tedlar®). In a decorative film configuration, it is also possible to place a transparent upper, protective surface over the gloss sections.

The gloss sections are preferably formed of a variety of resin formulations including pigments, dyes or other colorants that simulate a basic white coloration with varying degrees of gloss provided by incorporation of various resins and/or reflective materials. Alternatively the gloss sections could be of any rigid or flexible material, such as metal, cardboard, paper, textiles (woven or unwoven), wood, composite materials, leather, fiberglass, glass, clay or stone.

The gloss sections can be of any size, however, it is preferred that they are of a size useful for comparison with a dental surface such as the outer surface of a tooth, dental implant or denture. Thus, it is preferred that they approximate the size of a tooth, and range from about 0.5 to about 2.5 cm in height and width (measured in the transverse and longitudinal directions of the gloss sections). However, it may be desirable to have significantly larger gloss sections (e.g., to form a giant shade guide for in-store promotion) or significantly smaller (e.g., to form a travel-size shade guide).

The gloss sections can be arranged in varying configurations for ease of use, but are preferably arranged in some manner such that the gloss level increases from lowest to highest gloss. For example, the gloss sections can be arranged in a side-by-side configuration linearly along a substrate as shown in FIG. 1 or in a fanned semi-circular or circular configuration. A circular configuration embodiment shine chart 110 is illustrated in FIG. 3.

Other configurations can include square, oval, elliptical, quadrilateral, wavy, or any other desirable configuration.

The reflectivity of each of the plurality of gloss sections should range from a low gloss to a high gloss value. The lowest value can be a fully matte, non-reflective value of 0 gloss units, or since most dental surfaces are, at a dullest, at about 30 gloss units, the lowest value can be 30 gloss units. The highest value measurable using a gloss instrument for such dental surfaces is about 269 gloss units. However, a very high gloss dental surface polished using a fine diamond polish (about 0.05 microns) approximates 230 gloss units. Thus, the highest value can range from about 230 to about 269 or 270 gloss units or higher.

Each gloss section preferably increases in gloss units in equal increments, although ever-increasing scales are also possible. If equal increments are used, it is preferred that the gloss units increase by 20 units, 30 units, 50 units, etc. Most preferably, the gloss sections begin at 0 gloss units and increase in 30 gloss unit increments up to about 270 gloss units (or 269 gloss units depending on the formulation for making the gloss sections).

Such shine guides can be used for evaluating the gloss or shine effects of an untreated dental surface or a dental surface treated with a shine-enhancing dentifrice. It can also be configured for use with forming artificial dental pieces such as implants, crowns, implants and the like for evaluating the gloss or shine of a patient's tooth and that of the proposed artificial dental piece. Such shine guides can be configured similarly to those used for color guides and charts already known in the art, of which there are a wide variety, and used in conjunction therewith.

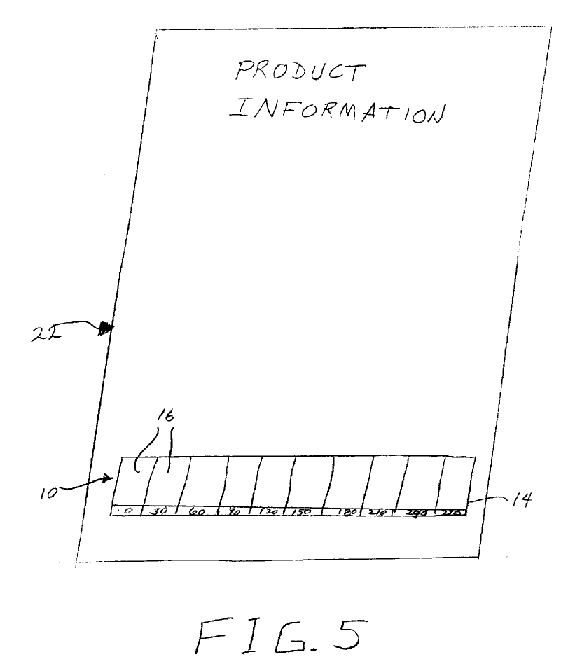

Also within the embodiments described herein is incorporation of the dental shine guide described herein in packaging for a dentifrice. Such packaging can include a box as shown in FIG. 4 used as a container for a dentifrice and/or a packaging insert as shown in FIG. 5. The shine guide 10 can be formed on one of the outer faces 18 of the box 20 and/or, can more preferably be included on a packaging insert 22. The insert can include strictly the shine guide 10 or can be a combination of information on the dentifrice as well as the shine guide as shown.

A method for evaluating a dental surface is also included herein. The method includes comparing the shine guide to a dental surface, which may be a natural human or animal tooth, or other artificial dental piece as noted hereinabove. After the comparison, the user can determine the current level of shine or gloss of the dental surface. Such a comparison can be made to an untreated dental surface or a treated dental surface. The dental surface, if treated, can be treated by using any suitable dentifrice as noted hereinabove, preferably a toothpaste or tooth polish that incorporates ingredients used to enhance shine or gloss of a dental surface such as a commercial product such as Colgate Luminous™. Thus, the dental surface can be evaluated with the shine guide prior to treatment and/or after treatment with such a dentifrice. The evaluation can be done on periodic occasions to determine changes in gloss or shine over time.

### EXAMPLE 1

### Protocol for Determining Gloss Units Value of Surface and Effective of Various Dentifrices

Samples were cut from bovine enamel (n=8/group) into blocks of 0.25 in and polished. The samples were then etched using a 1% HCl solution for 2 minutes to provide a uniform baseline level for testing. Specular reflectance measurements were taken on the enamel surfaces prior to testing, using a Tricor 806H gloss meter (having a high-gloss standard set at 269 gloss units.

A V-8 cross-brushing machine, set for application of 150 g brushing force was used in a brushing regimen of 13,600 strokes. Four treatment cells were evaluated. The first cell was a phosphate buffer control (Sample A). The next three cells (B)-(D) included three commercially available dentifrices: (Sample B) anti-cavity formula composed of dicalcium phosphate; (Sample C) anti-cavity formula composed of silica and (Sample D) Colgate Luminous™ high-cleaning silica. The samples were used in slurries of dentifrice and phosphate buffer solution (PBS) in a ratio of 1:1.6 dentifrice to PBS.

The Samples after treatment were evaluated for specular reflectance. The gloss-improvement values averaged over the 8 sets of bovine-enamel specimens. The mean gloss improvements for each treatment in gloss units were:

Sample A 112±19

Sample B 102±20

Sample C 120±30

Sample D 172±16

One-way ANOVA indicated that Sample D significantly and statistically improved specular reflectance of the enamel over the other Samples and the control (p<0.5). The Samples A-C were determined to be statistically equivalent. The polishing potential of Sample D appeared enhanced by the polishing properties of the high-cleaning silica.

### EXAMPLE 2

An enamel shine guide is prepared using a coated paper insert wherein the coating shows a range of gloss units in increments of 20 gloss units arranged from 0 gloss units up to 260 gloss units (the maximum setting). The shine guide is used to evaluate a control, sample enamel surfaces polished using the dentifrice of Sample D in Example 1 at varying polishing regimens and a sample polished with a diamond suspension.

Several Sample bovine enamel surfaces (Samples E-H) are prepared as in Example 1, with Sample E being prepared in the same manner as Sample A in Example 1. Sample E is not polished. Samples F-H are polished using the same brushing machine. Samples F-H are brushed at 150 g brushing force for a regimen of only 1,000 strokes, 5,000 strokes and 10,000 strokes, respectively. A further Sample I was prepared in the same manner as Samples E-H, but is polished with a small (0.05 micron) particle diamond suspension. The Samples E-I are then compared with the shine guide such that Sample E compares with 30 gloss units, Samples F-H compares to the shine guide at increasing gloss unit measurements greater than 30 gloss units and less than 230 gloss units and Sample I compares with 230 gloss units.

### EXAMPLE 3

Enamel shine guides are prepared as in Example 2, but having a range of gloss units in increments of 30 gloss units, 40 gloss units and 50 gloss units respectively, each arranged from a minimum of 0 gloss units up to a maximum of 270 gloss units, 260 gloss units and 250 gloss units respectively (the maximum settings). The shine guides are used to evaluate teeth polished using the dentifrice of Sample D in Example 1.

The shine guides are thus used to evaluate a base line, or control sample, as well as dental surfaces after treatment with a dentifrice.

1. A shine guide, comprising
a substrate having an upper surface; and
a plurality of gloss sections arranged on the upper surface of the substrate, wherein each of the plurality of gloss sections has a unique reflectivity measured in gloss units.

2. The shine guide according to claim 1, wherein the substrate comprises paper.

3. The shine guide according to claim 1, wherein the substrate comprises cardboard.

4. The shine guide according to claim 1, wherein the substrate comprises a polymer.

5. The shine guide according to claim 4, wherein the substrate comprises a homopolymer or copolymer of a polyamide, a polyvinyl, a polyolefin or combinations thereof.

6. The shine guide according to claim 1, wherein the upper surface of the substrate comprises a coating.

7. The shine guide according to claim 6, wherein the coating comprises a polymer or film.

8. The shine guide according to claim 1, wherein the plurality of gloss sections are arranged in a side-by-side configuration.

9. The shine guide according to claim 1, wherein the plurality of gloss sections are arranged in a fan configuration.

10. The shine guide according to claim 1, wherein the plurality of gloss sections are arranged in a circular configuration.

11. The shine guide according to claim 1, wherein the reflectivity of each of the plurality of gloss sections is independently about 0 gloss units to about 269 gloss units.

12. The shine guide according to claim 1, wherein each of the plurality of gloss sections has a reflectivity that increases successively in 20 gloss unit increments.

13. The shine guide according to claim 1, wherein each of the plurality of gloss sections has a reflectivity that increases successively in 30 gloss unit increments.

14. The shine guide according to claim 1, wherein each of the plurality of gloss sections has a reflectivity that increases successively in 50 gloss unit increments.

15. The shine guide according to claim 1, wherein the plurality of gloss sections are formed using film having varying reflectivities.

16. The shine guide according to claim 15, wherein each of the films has an upper layer having a reflectivity and a transparent protective layer over the upper layer which does not interfere with the reflectivity of the upper layer.

17. A package for a dentifrice having a shine guide, wherein the shine guide comprises
a substrate having an upper surface; and
a plurality of gloss sections arranged on the upper surface of the substrate, wherein each of the plurality of gloss sections has a unique reflectivity measured in gloss units.

18. The packaging according to claim 17, comprising a box for holding a container having a dentifrice, wherein the shine guide is located on an outer face of the box.

19. The packaging according to claim 17, comprising a packaging insert, wherein the shine guide is located on the insert.

20. The packaging according to claim 19, wherein the packaging insert further comprises information about the dentifrice in addition to the shine guide.

21. A method for evaluating shine of a dental surface, comprising comparing a dental surface to a dental shine guide.

22. The method according to claim 21, further comprising applying a dentifrice to the dental surface prior to comparing the dental surface to the dental shine guide.

23. The method according to claim 22, further comprising polishing the dental surface with the dentifrice after applying the dentifrice to the dental surface and prior to comparing the dental surface to the shine guide.
